(19) United States
(12) Patent Application Publication
(10) Pub. No.: US 2011/0044081 A1
(43) Pub. Date: Feb. 24, 2011

(54) Full-wave rectifier

(76) Inventor: Chao-Cheng Lu, Taipei (TW)

Correspondence Address: LU, CHAO-CHENG;4-4, Alley 27, Lane 143, Jun Gong Road, Taipei, 11655, TW

(21) Appl. No.: 12/583,537

(22) Filed: Aug. 24, 2009

(51) Int. Cl. H02M 7/217

(52) U.S. Cl. 363/127

(57) ABSTRACT

A full-wave rectifier of the present invention, has an input AC power source, a pair of input terminal A and B, a pair of first and second switching element Q1 and Q2 comprises a first and a second Lus P-Channel FET, a pair of third and fourth switching element Q3 and Q4 comprises a third and a fourth Lus N-Channel FET, a pair of driving element R1 and R2, a load L1 and DC voltage output terminal C and D, the major function of AC to DC conversion.

### BACKGROUND OF THE INVENTION

1. Field of the Invention

The present invention related to enhancement mode Lus FET for full-wave rectifier, especially Lus FET with novel structures replacing prior art static shielding diode (SSD) or body diode, in prior art FET may be with polarity reversed are taught by the ROC. TW. Pat. Nos. I 295,527; I 295,528; I 301,013; I 301,014; I 301,015. According to such philosophy of the present invention, the full-wave rectifier may be achieved use two Lus P-Channel FET, two Lus N-Channel FET, and driving circuit. Hence, functions of minimizing voltage drop between Alternating Current (AC) and Direct Current (DC) voltage output terminal of the full-wave rectifier may be achieved.

2. Description of Related Art

As shown in FIGS. 5A and 5B, a structure of the prior art full-wave rectifier circuit, has an input AC power source, a pair of input terminal A,B, a pair of first and second switching element F1, F2, a pair of third and fourth switching element F3, F4, a pair of driving element R1, R2, a load L1, and DC voltage output terminal C, D.

Each of the first and second switching element F1, F2, comprises a prior art P-Channel FET shown in FIGS. 5A, and 5B, each of the third and fourth switching element F3, and F4, comprises a prior art N-Channel FET shown in FIGS. 5A, and 5B.

As shown in FIG. 5A, when the positive half-wave of the AC power source in the A terminal, B terminal is negative half-wave of the AC power source, the switching element F1 and F4 is turned on, the switching element F2 and F3 is turned off, the path of the current flow is from A terminal of AC power source though the switching element F1, static shielding diode D2 of switching element F2, and back to B terminal of the AC power source, the possibility that the F1 and F2 may be burnout by current of the prior art P-Channel FET. Another path of the current flows is from A terminal of AC power source though static shielding diode D3 of the switching element F3, switching element F4, and back to B terminal of the AC power source, the possibility that the F3 and F4 may be burnout by current of the prior art N-Channel FET.

As shown in FIG. 5B, when the negative half-wave of the AC power source in the A terminal, B terminal is positive half-wave of the AC power source, the switching element F2 and F3 is turned on, the switching element F1 and F4 is turned off, the path of the current flow is from B terminal of the AC power source though the switching element F2, static shielding diode D1 of the switching element F1 and back to A terminal of AC power source, the possibility that the switching element F2 and F1 may be burnout by the current of prior art P-Channel FET. Another path of the current flows is from B terminal of AC power source though the static shielding diode D4 of the switching element F4, switching element F3 and back to A terminal of the AC power source, the possibility that the switching element F4 and F3 may be burnout by current of the prior art N-Channel FET.

### SUMMARY OF THE INVENTION

In order to provide semiconductor devices that may elevate the efficiency of full-wave rectifier, the present invention is proposed the following object:

The first object of the present invention is to provide Lus FET for full-wave rectifier, can be eliminate the drawback of burnout of prior art FET.

The second object of the present invention is to provide Lus FET for full-wave rectifier that eliminate the drawback of high power consumption of prior art full-wave rectifier utilizing diode.

According to the defects of the prior art technology discussed above, a novel solution, the Lus FET is proposed in the present invention, which provides higher efficiency in full-wave rectifier.

### BRIEF DESCRIPTION OF THE DRAWINGS

FIG. 1 shows the structures of a prior art N-Channel FET.

FIG. 2 shows the structures of a Lus N-Channel FET.

FIG. 3 shows the structures of a prior art P-Channel FET.

FIG. 4 shows the structures of a Lus P-Channel FET.

FIGS. 5A and 5B shows the structures of a prior art FET for full-wave rectifier.

FIGS. 6A and 6B shows the full-wave rectifier of the present invention use first driving element and second driving element of the driving circuit.

FIGS. 7A and 7B shows the full-wave rectifier of the present invention use first driving element, second driving element, and voltage drop element of the driving circuit.

### DETAILED DESCRIPTION OF THE PREFERRED EMBODIMENTS

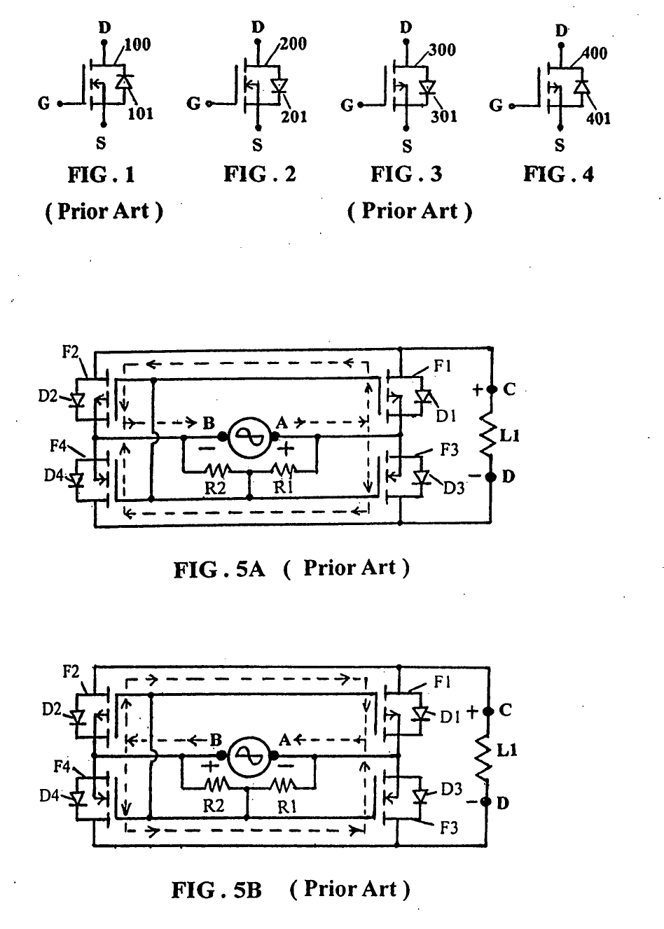

FIG. 1 shows the structures of a prior art N-Channel FET, a N-junction of the SSD connected to drain of the prior art N-Channel FET, a P-junction of the SSD connected to source of the prior art N-Channel FET.

FIG. 2 shows the structures of a Lus N-Channel FET, a N-junction of the SSD connected to source of the Lus N-Channel FET, a P-junction of the SSD connected to drain of the Lus N-Channel FET.

FIG. 3 shows the structures of a prior art P-Channel FET, a N-junction of the SSD connected to source of the prior art P-Channel FET, a P-junction of the SSD connected to drain of the prior art P-Channel FET.

FIG. 4 shows the structures of a Lus P-Channel FET, a N-junction of the SSD connected to drain of the Lus P-Channel FET, a P-junction of the SSD connected to source of the P-Channel FET.

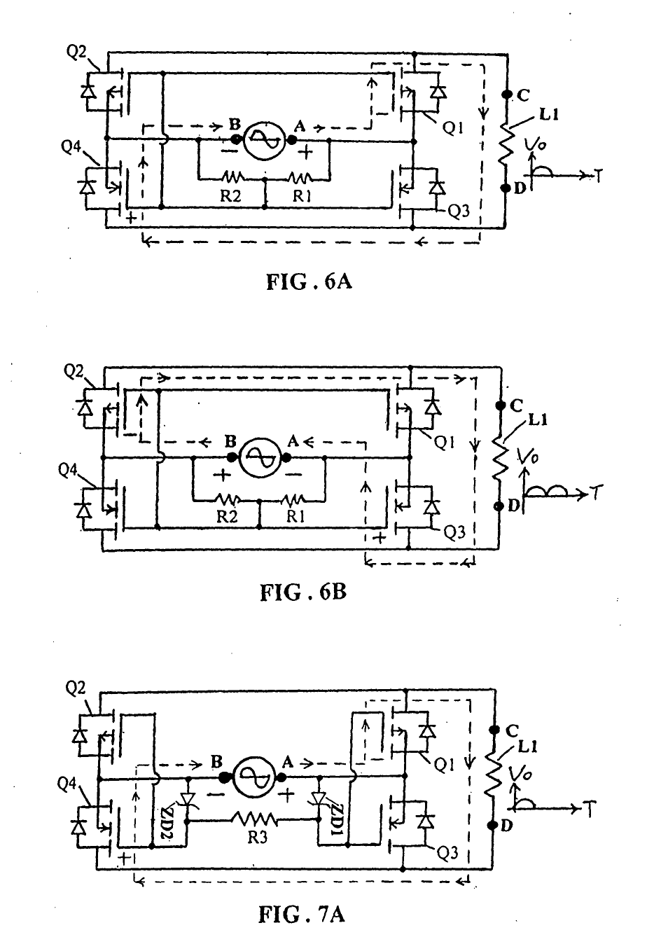

FIGS. 6A and 6B, shows a full-wave rectifier of the present invention, has an input AC power source, a pair of input terminal A and B, a pair of first and second switching element Q1 and Q2, a pair of third and fourth switching element Q3 and Q4, a pair of driving element R1 and R2, a load L1 and DC voltage output terminal C and D.

As shown in FIG. 6A, when the positive half-wave of the AC power source in the A terminal, B terminal is negative half-wave of the AC power source, the first terminal is negative of the first driving element R1, the first terminal of the second driving element R2 and the second terminal of the first element R1 connected together to gate of the switching elements Q1, Q2, Q3, and Q4, the first terminal is positive of the second driving element R2, the second terminal is negative of the second driving element R2, the switching element Q1 and Q4 is turned on, Q2 and Q3 is turned off, the path of the current flow is from A terminal of AC power source though the switching element Q1, load L1, switching element Q4 and back to B terminal of the AC power source.

As shown in FIG. 6B, when the negative half-wave of the AC power source in the A terminal, B terminal is positive half-wave of the AC power source, the first terminal is negative of the first driving element R1, the second terminal is positive of the first driving element R1, the first terminal of the second driving element R2 and the second terminal of the first element R1 connected together to gates of the switching elements Q1, Q2, Q3, and Q4, the first terminal is negative of the second driving element R2, the second terminal is positive of the second driving element R2, the switching element Q2 and Q3 is turned on, Q1 and Q4 is turned off, the path of the current flow is from B terminal of AC power source though the switching element Q2, load L1, switching element Q3 and back to A terminal of the AC power source.

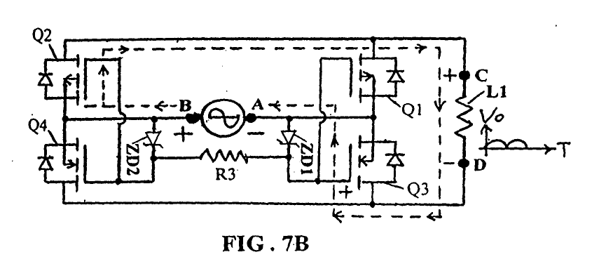

As shown in FIGS. 7A and 7B, the voltage drop element R3 is series connected to between the first and second driving element Zener diode ZD1, Zener diode ZD2, the driving voltage is equal to the voltage drop of the driving element ZD1, ZD2, the voltage drop element R3 in order to perform the function of gate-source voltage of the switching elements Q1, Q2, Q3, and Q4.

The operation principle of the FIGS. 7A and 7B is same as the embodiment that is illustrated in FIGS. 6A and 6B. Hence, function of full-wave rectifier may be achieved.

What is claimed is:

1. A full-wave rectifier comprises:
a first and second Lus P-Channel FET;
the drain of first and second Lus P-Channel FET in combination forming a positive DC voltage output terminal;
a third and fourth Lus N-Channel FET;
the drain of third and fourth Lus N-Channel FET in combination forming a negative DC voltage output terminal;
the source of first Lus P-Channel FET and third Lus N-Channel FET in combination forming a first AC power source input terminal;
the source of second Lus P-Channel FET and fourth Lus N-Channel FET in combination forming a second AC power source input terminal; and
a driving circuit connected to first and second AC power source input terminal for driving gates of four Lus FET.

2. A full-wave rectifier as in claim 1, wherein:
the drain of first and second Lus P-Channel FET in combination forming a positive DC voltage output terminal;
the source of first Lus P-Channel FET is connected to the first AC power source input terminal; and
the source of second Lus P-Channel FET is connected to the second AC power source input terminal.

3. A full-wave rectifier as in claim 1, wherein:
the drain of third and fourth Lus N-Channel FET in combination forming a negative DC voltage output terminal;
the source of third Lus N-channel FET is connected to the first AC power source input terminal; and
the source of fourth Lus N-Channel FET is connected to the second AC power source input terminal.

4. A full-wave rectifier as in claim 1, wherein said driving circuit comprises a first and second driving element.

5. A full-wave rectifier as in claim 4, wherein said first and second driving element comprises the series-connected circuit of the first and second resistors.

6. A full-wave rectifier as in claim 1, wherein said driving circuit comprises first, second driving element and voltage drop element.

7. A full-wave rectifier as in claim 6, wherein said first, second driving element and voltage drop element comprises the series-connected circuit of the first Zener diode, second Zener diode and third resistors.

8. A full-wave rectifier as in claim 4, wherein:
said first terminal of the first driving element connected to said first AC power source input terminal;
said second terminal of the first driving element and said first terminal of the second driving element connected together to said gate of the first and second Lus P-Channel FET;
said second terminal of the first driving element and said first terminal of the second driving element connected together to said gate of the third and fourth Lus N-Channel FET; and
said second terminal of the second driving element connected to said AC Power source input terminal.

9. A full-wave rectifier as in claim 6, wherein:
said first terminal of the first driving element connected to said first AC power source input terminal;
said second terminal of the first driving element and said first terminal of the voltage drop element connected together to said gate of the first Lus P-Channel FET and third Lus N-Channel FET;
said second terminal of the voltage drop element and said first terminal of the second driving element connected together to said gate of the second Lus P-Channel FET and fourth Lus N-Channel FET; and
said second terminal of the second driving element connected to second AC power source input terminal.
